(19) United States
(12) Patent Application Publication
(10) Pub. No.: US 2008/0050531 A1
(43) Pub. Date: Feb. 28, 2008

(54) Apparatus and method for wetting a continuous web

(75) Inventor: Andrew M. Lake, Appleton, WI (US)

Correspondence Address: RYAN KROMHOLZ & MANION, S.C., POST OFFICE BOX 26618, MILWAUKEE, WI, 53226, US

(73) Assignee: Curt G. Joa, Inc.

(21) Appl. No.: 11/895,879

(22) Filed: Aug. 28, 2007

Related U.S. Application Data
(60) Provisional application No. 60/840,555, filed on Aug. 28, 2006.

(51) Int. Cl. B05D 1/02; B05B 13/02

(52) U.S. Cl. 427/421.1; 118/325

(57) ABSTRACT

An apparatus and method are provided for wetting a continuous web. An apparatus according to the present invention includes a dwell surface adapted to receive a traveling web and a fluid chamber in fluid communication with such traveling web. The fluid chamber is coupled to a fluid source. Fluid from the fluid chamber is applied to the web and the web is drawn across the dwell surface. The web may be drawn away from the dwell surface at an angle that may be adjustable. Alternatively, an embodiment of the apparatus includes a plurality of dwell surfaces, one of which may be selectively engaged with the traveling web. A method according to the present invention involves the steps of providing a continuous web, applying a fluid to the web and drawing the web across a dwell surface.

### RELATED APPLICATION

This application claims the benefit of co-pending U.S. Provisional Patent Application No. 60/840,555, filed 28 Aug. 2006.

### BACKGROUND OF THE INVENTION

Generally, the present invention relates to material impregnation. More specifically, the present invention is directed to an apparatus and method for wetting a traveling continuous web with a fluid.

Prior art methods exist for wetting a traveling web. However, these methods are limiting, especially with respect to the speed of the traveling web. Physical characteristics of hydrophilic webs such as basis weight, porosity, fiber composition and chemical additives dramatically influence the capacity and absorption rates of different web structures. This is especially true when the intake, wicking and retention properties of a web pre-determine the saturation level at a given speed.

One prior art method of wetting a traveling web with fluid is to draw the web through a trough of fluid, thereby deluging the web with a large amount of fluid for a predetermined time. The web submersion time thus at least partially controls the amount of fluid absorbed by the web. Since submersion time controls the level of absorption, alterations of the speed of the traveling web will change the submersion time and therefore the absorption level. Very high speed web travel may result in a less than the desired of fluid being absorbed by the web. Furthermore, deluging a web that is traveling at high speed creates a large mess in the physical space surrounding the trough. To remedy such mess, prior art devices utilize larger troughs with splash protection or nip rolls to squeeze the excess fluid from the web and back into the trough. Larger troughs take up valuable manufacturing space and nip rolls are simply further mechanical devices that may increase maintenance cost. Thus, an apparatus that provides desired absorption levels to be largely independent of the speed of a traveling web while minimizing mess is desirable.

Another prior art method of wetting a web is by a spraying or a fountain technique. Like the deluge or submersion technique, fountain application of a fluid to a web causes a great deal of mess, usually requiring a shielding housing. Furthermore, in applications for sterile products, recovery of the excess sprayed fluid may be undesirable. Therefore, it is desirable to have an apparatus that minimizes excess fluid use and further minimizes fluid exposure to ambient conditions.

As mentioned briefly, some prior art devices utilize nip rolls placed downstream from the fluid application station. The nip rolls reduce the amount of fluid contained in the web to some predetermined level. The reduction of the amount of fluid contained in an oversaturated web results in fluid released from the web that is either wasted or may be recovered. Therefore, an apparatus that provides accurate control of web saturation or absorption levels while largely avoiding fluid waste and the need for fluid recovery is desirable.

Another prior art method of wetting a traveling web is to use a so-called drool bar. The web travels around the bar while fluid is pumped through the bar at a desired rate. Prior art drool bars, while sufficient for some applications, do not allow precise control over the saturation level of the web. An especially noticeable problem is encountered when significant saturation is required. At high speeds, a traveling web does not dwell for enough time near the fluid application point so as to allow sufficient absorption. Therefore, despite a possible increased flow out of the drool bar, the web is unable to absorb the fluid fast enough, thereby causing spilled fluid and undesirable web saturation levels. One method used in the past was to cause web travel over several drool bars to ensure proper saturation. Therefore, the art would benefit from an apparatus that provides sufficient wetting of a traveling web by allowing adequate absorption dwell time for contact between the web and fluid.

### SUMMARY OF THE INVENTION

The present invention provides an apparatus and method for wetting a traveling continuous web. The apparatus and method allow the speed of the traveling web to change independently of the exposure to the wetting agent. Also, the present invention provides more precise control of web exposure to the desired fluid, minimizes fluid exposure to ambient conditions, and minimizes fluid loss. Furthermore, the apparatus provides sufficient absorption time to reach a desired web saturation level.

An embodiment of the present invention provides an apparatus for wetting a continuous web. The apparatus includes a dwell surface adapted to receive a continuous web. The dwell surface may be arcuate in shape. The web is traveling over the dwell surface in a web direction for a determinable dwell time period. The apparatus further includes a fluid chamber coupled to a fluid source. The fluid chamber is in fluid communication with the web that is traveling over the dwell surface. The dwell surface may include a leading edge and a trailing edge, which is downstream in the web direction from the leading edge. The fluid communication between the fluid chamber of the apparatus and the web may be provided by one or more apertures formed through the dwell surface and disposed between the leading and trailing edges of the dwell surface. In one embodiment, the apertures are situated closer to the leading edge than to the trailing edge. The dwell surface may have first and second ends, where a traveling web is positioned between the ends. In one embodiment, the dwell surface is stationarily supported at one of the ends during operation. In another embodiment, the surface is stationarily supported at both ends during operation. The dwell surface may be formed from a variety of materials. In one embodiment, it is formed from stainless steel.

If the dwell surface is arcuate, a web traveling over the arcuate dwell surface exits engagement with the arcuate surface at a trailing angle, which may be defined as the angular relationship between a tangent of the arcuate dwell surface at the trailing edge and the traveling web. The trailing angle may be adjustable, either by an adjustment means provided on the apparatus or by some other means, such as the relative situation of the apparatus within the manufacturing environment. In one embodiment, the trailing angle is adjustable from about zero degrees to about ninety degrees. The trailing angle is preferably set to a constant position during the manufacturing process. In one embodiment, the trailing angle is set to zero to twenty degrees. In another embodiment, the trailing angle is set to one to ten degrees.

An embodiment of the present invention also provides a method of wetting a continuous traveling web. The method includes providing a web traveling in a web direction, applying a fluid flow, which is greater than ambient fluid exposure, to the web, thereby creating a impregnated web segment; and drawing at least a portion of the impregnated web segment across a dwell surface, which may be arcuate. In one embodiment, the fluid flow is applied to the web through said dwell surface. Also, in an embodiment, the drawing step occurs after said applying step, contemporaneously with a change in said web direction, or prior to performing any further manufacturing operations on the web.

### BRIEF DESCRIPTION OF THE DRAWINGS

FIG. 1 is a diagrammatic representation showing a traveling web traveling over an embodiment of the present invention.

FIG. 2 is a perspective view of an embodiment of the present invention.

FIG. 3 is a cross-section view taken along line 3-3 in FIG. 2.

FIG. 4 is a front elevation view of the embodiment in FIG. 2.

FIG. 5 is a front elevation of a second embodiment of the present invention.

FIG. 6 is a front elevation view of a third embodiment of the present invention.

FIG. 7A is a side elevation view of a fourth embodiment of the present invention.

FIG. 7B is a side elevation view of the fourth embodiment of FIG. 7A after rotation by 180 degrees.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

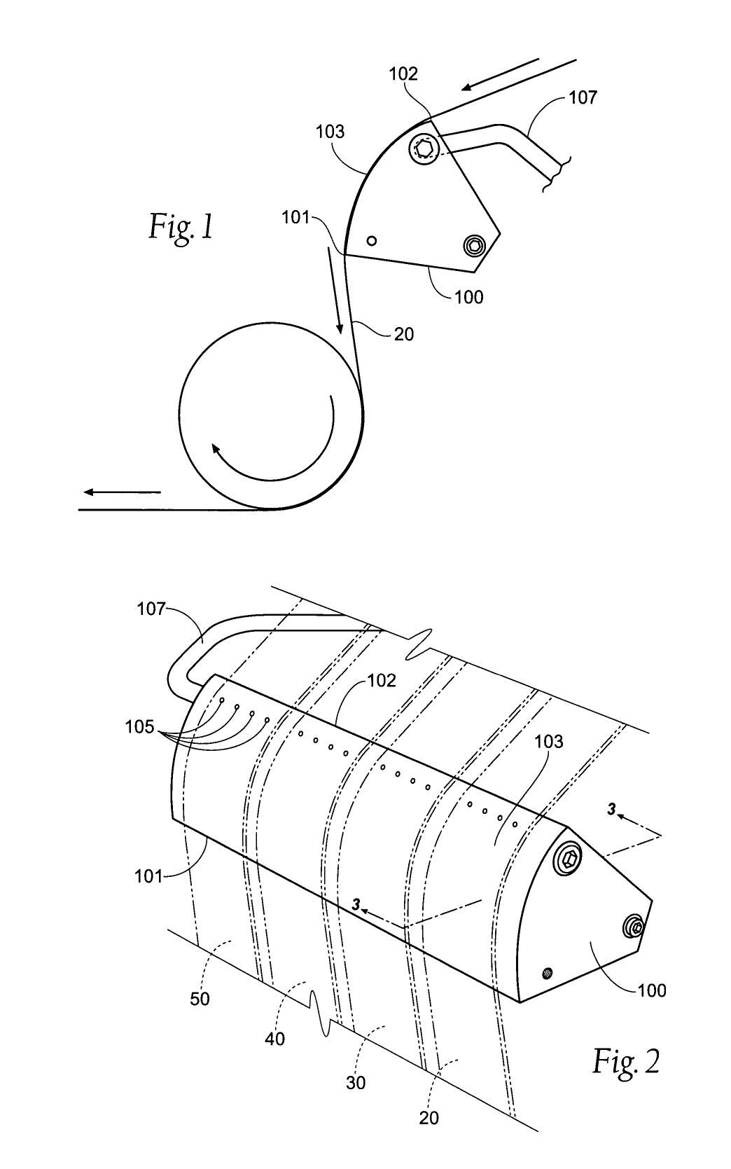

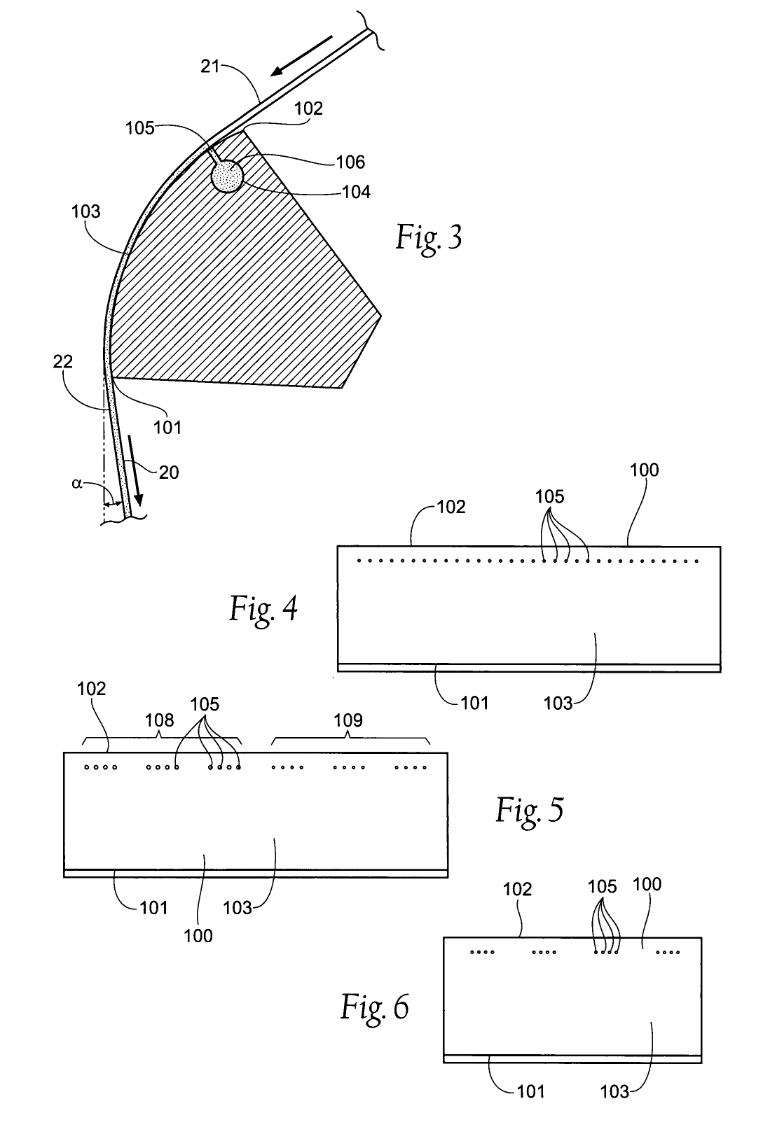

Referring to FIG. 1, a diagrammatic view of a web 20 traveling over an embodiment 100 of the present invention is shown. Referring also to FIGS. 2 and 3, the apparatus 100 has a leading edge 102, a trailing edge 101, a fluid permeable dwell surface 103, which is arcuate in this embodiment 100, that extends at least partially between the leading edge 102 and the trailing edge 101, and an internal chamber 104. The fluid permeability of the surface 103 is preferably caused by a plurality of perforations 105. When the web 20 is placed across the surface 103, the chamber 104 is in fluid communication with the traveling web 20 through the perforations 105, as best shown in FIG. 3. Fluid 106 is supplied to the chamber 104 by a fluid supply line 107, which may be fed by a pump (not shown) or by an elevated tank (not shown). Although adjustable, the apparatus 100 is preferably stationary during operation and is anchored, preferably at each end of the apparatus 100. The fluid permeable surface 103 can be adapted to accommodate a single traveling web 20 or multiple traveling webs 20,30,40,50.

Wicking or absorption of fluid 106 into a web 20 requires some finite time of exposure of the web 20 to the fluid 106. The arcuate surface 103 provides the desired time for fluid 106 to be absorbed into the web 20. The web 20 is preferably drawn off of the trailing edge 101 at an angle α relative the tangent of the arcuate surface 103. This provides an additional means to cleanly force entrapped fluid 106 located between the surface 103 and the web 20 into the structure of the web 20, thereby overcoming some limitations of web intake, wicking and absorptive properties. The angle α is preferably between and including zero and ninety degrees, more preferably between and including zero and twenty degrees, but most preferably between and including one and ten degrees. Thus, the trailing edge 101 helps to force the applied fluid 106 into the web 20.

The apparatus 100 is preferably made of any rigid material and the fluid permeable surface 103 preferably has a low wet friction coefficient to ease the transfer of the traveling web 20. Stainless steel is sufficient for most applications. Furthermore, the apparatus does not have to be solid, as shown in FIG. 3. The apparatus generally has a fluid flow conduit or chamber 104 and an arcuate surface 103 below the fluid application points 105.

To use the apparatus 100, a web 20 is supplied and situated to travel over the fluid permeable surface 103. When wetting is desired, the fluid 106 is forced out of the chamber 104, through the permeable surface 103 and into the web 20. The fluid 106 is forced out of the chamber 104 preferably by a pressure differential created on opposing sides of the fluid permeable surface 103. The pressure differential can be created by the pump attached to the fluid supply line 107, by gravity, if the fluid supply line 107 is fed from an elevated tank, or by other means such as a mechanical or pneumatic plunger. Thus, prior to encountering the leading edge 102 of the arcuate surface 103, the web 20 is relatively dry 21. After fluid 106 is provided to the web 20 through the perforations 105, the web 20 travels over the remainder of the arcuate surface 103. The travel time over the arcuate surface 103 provides an increased contact time between the web 20 and any excess fluid 106 that was not previously absorbed by the web 20. After leaving the trailing edge 101, the web 20 is more saturated 22 than when the web 20 encountered the leading edge 102.

As seen in FIGS. 4-6, the apparatus 100 can be any suitable width to accommodate the desired web 20 to be wetted. The perforation 105 pattern of the means by which the chamber 104 fluidly communicates with a traveling web 20 is generally related to the web 20 dimensions and wetting requirements. Since the level of saturation of a traveling web 20 is dependent on both the speed of travel and the amount of fluid 106 applied to the web 20, the apparatus 100 may be constructed to provide differing amounts of fluid 106 to different webs traveling over the surface 103. Specifically referring to FIG. 5, one group 108 of perforation 105 patterns provides more fluid 106 to a traveling web 20 than the other group 109 of perforation 105 patterns. Furthermore, the rate at which the fluid 106 is applied to a traveling web 20 is controllable through various parameters. One way to alter the saturation level is through an increased pressure differential created in the chamber 104, which increases flow of fluid through the perforations 105. Another way that more or less fluid 106 can be applied to the web 20 is by altering the size of the perforations 105. Smaller perforations 105 will provide less fluid 106 while larger perforations 105 will provide a greater amount of fluid 106 to the traveling web 20. Saturation time can also be modified by changing the length of the arcuate surface 103. Greater levels of saturation can be achieved by increasing the fluid flow and the dwell time during which the web 20 is in contact with the fluid 106.

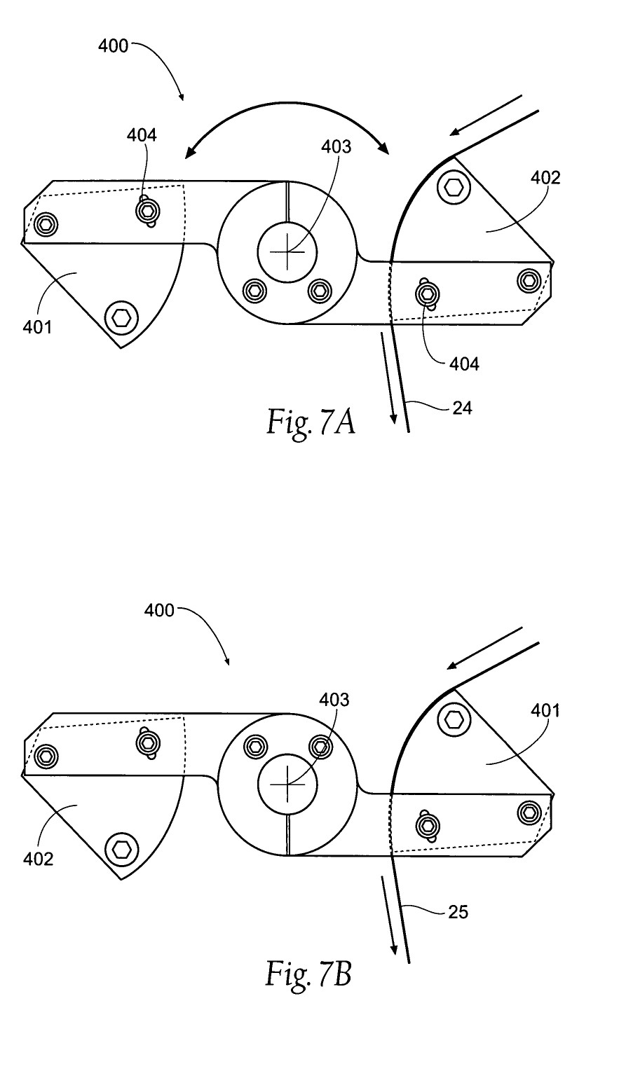

As seen in FIGS. 7A and 7B, a plurality of apparatuses 401,402 may be mounted to a single unit 400 on a rotatable axis 403. Each apparatus likely has some different attribute than the others. For example one apparatus 401 may be longer to provide a wetting surface for a wide web 24, as opposed to the other 402, which provides a shorter wetting surface for a narrow web 25. Also, one apparatus 402 may have a different perforation pattern than the other 401, depending upon saturation preferences for the webs 24,25, respectively. A supply line (not shown) could connect to the chambers 104 of the apparatuses 401,402 through the main rotating body, or, alternatively, the apparatuses could have a selectively engageable fluid communication port to which a supply line connects. The apparatuses 401,402 may also be provided by an angle adjustment means 404, thereby allowing alterations in the increase or decrease of web contact with the leading and trailing edges of the apparatuses 401,402.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An apparatus for wetting a continuous web, said apparatus comprising:
a dwell surface adapted to receive a continuous web, said web traveling over said dwell surface in a contacting relationship, in a web direction, for a determinable dwell time period; and,
a fluid chamber coupled to a fluid source, said fluid chamber in fluid communication with said traveling web.

2. An apparatus according to claim 1, wherein said dwell surface is arcuate.

3. An apparatus according to claim 1, wherein said web travels in said web direction over said dwell surface from a leading edge towards a trailing edge.

4. An apparatus according to claim 3, further comprising an aperture through said dwell surface, thereby enabling said fluid communication between said fluid chamber and said traveling web.

5. An apparatus according to claim 4, said aperture being positioned between said leading edge and said trailing edge.

6. An apparatus according to claim 5, said aperture being positioned closer to said leading edge than said trailing edge.

7. An apparatus according to claim 2, wherein said web travels in said web direction over said arcuate dwell surface from a leading edge towards a trailing edge, said web leaving said trailing edge of said arcuate dwell surface at a trailing angle, said trailing angle defined as the angular relationship between a tangent of said arcuate dwell surface at said trailing edge and said traveling web.

8. An apparatus according to claim 7, said trailing angle being adjustable to a trailing angle set point.

9. An apparatus according to claim 8, said apparatus including a trailing angle adjustment means.

10. An apparatus according to claim 7, said trailing angle being adjustable from about zero degrees to about ninety degrees.

11. An apparatus according to claim 7, said trailing angle being zero to twenty degrees.

12. An apparatus according to claim 11, said trailing angle being one to ten degrees.

13. An apparatus according to claim 1, said dwell surface comprising a first end and a second end, said traveling web positioned between said first end and said second end.

14. An apparatus according to claim 13, said dwell surface being stationarily supported at at least one end during apparatus operation.

15. An apparatus according to claim 1, said dwell surface being formed from stainless steel.

16. A method of wetting a continuous traveling web, said method comprising the steps of:
providing a web traveling in a web direction;
applying a fluid to said web, thereby creating an impregnated web segment; and,
drawing at least a portion of said impregnated web segment across, and in a contacting relationship to, a dwell surface.

17. A method according to claim 15, wherein said fluid is applied to said web through said dwell surface.

18. A method according to claim 15, wherein said drawing step occurs after said applying step.

19. A method according to claim 15, wherein said drawing step occurs contemporaneously with a change in said web direction.

20. A method according to claim 15, wherein said drawing step occurs prior to performing any further manufacturing operations on said web.

21. A method according to claim 15, wherein said dwell surface is arcuate.
